(19) United States
(12) Patent Application Publication
(10) Pub. No.: US 2013/0286910 A1
(43) Pub. Date: Oct. 31, 2013

(54) POWER SAVING SYSTEM FOR SMART MOBILE COMMUNICATION DEVICE IN INTERNET COMMUNICATION

(71) Applicant: NATIONAL TAIPEI UNIVERSITY OF TECHNOLOGY, Taipei (TW)

(72) Inventors: Shaw Hwa Hwang, Taipei (TW); Ning Yun Ku, Taipei (TW); Chao Ping Chu, Taipei (TW); Tzu Hung Lin, Taipei (TW); Bing Chih Yao, Taipei (TW)

(73) Assignee: NATIONAL TAIPEI UNIVERSITY OF TECHNOLOGY, Taipei (TW)

(21) Appl. No.: 13/650,551

(22) Filed: Oct. 12, 2012

(30) Foreign Application Priority Data
Apr. 27, 2012 (TW) 101115184

(51) Int. Cl. H04W 52/02

(52) U.S. Cl. 370/311

(57) ABSTRACT

The present invention provides a power saving system for smart mobile communication device in Internet communication. The power saving system comprises two smart mobile communication devices with Internet connection capability, an Internet, a server, a gateway and a mobile communication network. The two smart mobile communication devices cut off the Internet connection usually. When a smart mobile communication device performs a call through the Internet to the other smart mobile communication device, the server, the gateway and the mobile communication network are used to inform the other smart mobile communication device for Internet connection. After both sides stop the Internet communication, the two smart mobile communication devices cut off the Internet connection.

### FIELD OF THE INVENTION

The present invention relates to a power saving system for smart mobile communication device in Internet communication, and more particularly to that the smart mobile communication device usually cuts off the Internet connection until someone uses Internet communication system to perform calling, then a server will inform the smart mobile communication device through a mobile communication network to perform Internet connection for communication. After both sides stop the Internet communication, then the smart mobile communication device cuts off the Internet connection.

### BACKGROUND OF THE INVENTION

Smart mobile communication device brings many conveniences for everyday life, for example, a smart phone not only can perform multimedia audio/video playing, taking pictures, playing games, listening music, but also can do web browsering, map touring, E-mail processing, . . . etc.

But the power duration is a great problem for the smart mobile communication device. Power consumption for the smart mobile communication device comes from the processor, application software, wireless devices . . . etc., especially the WiFi and 3G devices. After a radio chip in the smart mobile communication device performs Internet connection, the radio chip will do its best to keep Internet connection smoothly. When the Internet signal becomes weak, the radio chip will increase its transmission power so as to increase the power consumption.

Internet communication systems (IP Phone, Skype, MSN, Yahoo!messenger) are broadly used by the smart mobile communication device. In order to be called anytime, the smart mobile communication device has to be connected with the Internet communication system all the time. As mentioned above, when the smart mobile communication device connects with the WiFi or 3G network, the radio chip will do its best to keep Internet connection, so even at a standby status, the power consumption is much more than a cut off status, therefore the standby time for the smart mobile communication device is shortened significantly.

### SUMMARY OF THE INVENTION

The present invention provides a power saving system for smart mobile communication device in Internet communication, comprising:

a first smart mobile communication device having Internet connection capability;

a second smart mobile communication device having Internet connection capability;

an Internet;

a mobile communication network;

a server;

a gateway;

the first and the second smart mobile communication device usually cut off the Internet connection;

when the first smart mobile communication device calls the second smart mobile communication device through the Internet, the server will judge if the second smart mobile communication device is on-line, if yes, then do some verifications, exchange communication messages for both sides; if no, then the server will use the mobile communication network through the gateway to inform the second smart mobile communication device for Internet connection; after the second smart mobile communication device receives the informing, the second smart mobile communication device begins Internet connection, and registers to the server; then the server knows an Internet address of the second smart mobile communication device, so as to exchange communication messages for both sides; after both sides stop the Internet communication, the first and the second smart mobile communication device cut off the Internet connection.

The Internet can be replaced by IP Phone, Skype, MSN or Yahoo! messenger.

The smart mobile communication device can be a smart phone, a tablet PC or a PDA having smart communication capability.

The Internet is a WiFi/3G system, but other network system that can provide wireless connection between the first and the second smart mobile communication devices can also be used.

The mobile communication network can use a short message to inform the second smart mobile communication device for Internet connection.

The gateway can be replaced by other device that can connect between two different networks and can handle the transformation of communication protocols.

### BRIEF DESCRIPTION OF THE DRAWINGS

FIG. 1 shows schematically an environment of a power saving system for smart mobile communication device in Internet communication system

FIG. 2 shows schematically a smart phone registers to a server through ChungHwa Telecommunication Internet.

FIG. 3 shows schematically a “success of registration” message is sent to the smart phone after the verification by the server is succeeded.

FIG. 4 shows schematically the smart phone sends out “dialing 092x-xxxxxx” message.

FIG. 5 shows schematically a server uses ChungHwa Telecommunication 2G/3G for dialing the other smart phone.

FIG. 6 shows schematically the other smart phone rings, and the phone number of the incoming call is the number 2771 of the gateway.

FIG. 7 shows schematically the other smart phone cancels the calling through ChungHwa Telecommunication 2G/3G.

FIG. 8 shows schematically the other smart phone connects with the ChungHwa Telecommunication Internet and registers to the server.

FIG. 9 shows schematically a “success of registration” message is sent to the other smart phone after the verification by the server is succeeded.

FIG. 10 shows schematically “dialing 092x-xxxxxx” message is sent by the server.

FIG. 11 shows schematically the other smart phone begins ringing and the phone number of the incoming call is 091x-xxxxxx.

FIG. 12 shows schematically the other smart phone picks up the call, both sides begin communication.

FIG. 13 shows schematically both sides cut off the WiFi/3G Internet connections.

FIG. 14 shows schematically the procedures of VoIP.

### DETAILED DESCRIPTIONS OF THE PREFERRED EMBODIMENT

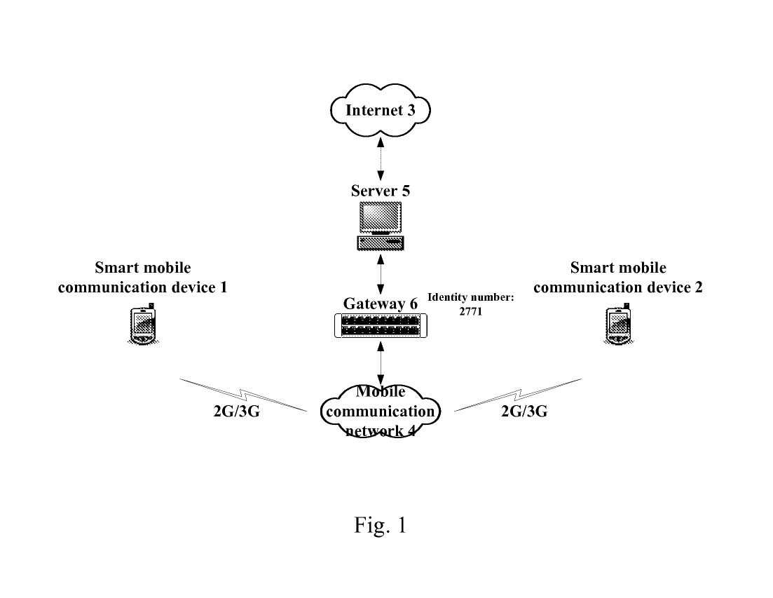

Referring to FIG. 1, an environment of power saving system for the smart mobile communication device in Internet communication system is shown. Both the Internet 3 and the mobile communication network 4 are prepared for the smart mobile communication device 1 and 2. When the smart mobile communication device 1 calls the smart mobile communication device 2 (IP Phone, Skype, MSN, Yahoo! messenger) through Internet 3, while the smart mobile communication device 2 is not on-line, then the Internet 3 will pass through the server 5, gateway 6, mobile communication network 4, short message to inform the smart mobile communication device 2 for Internet connection.

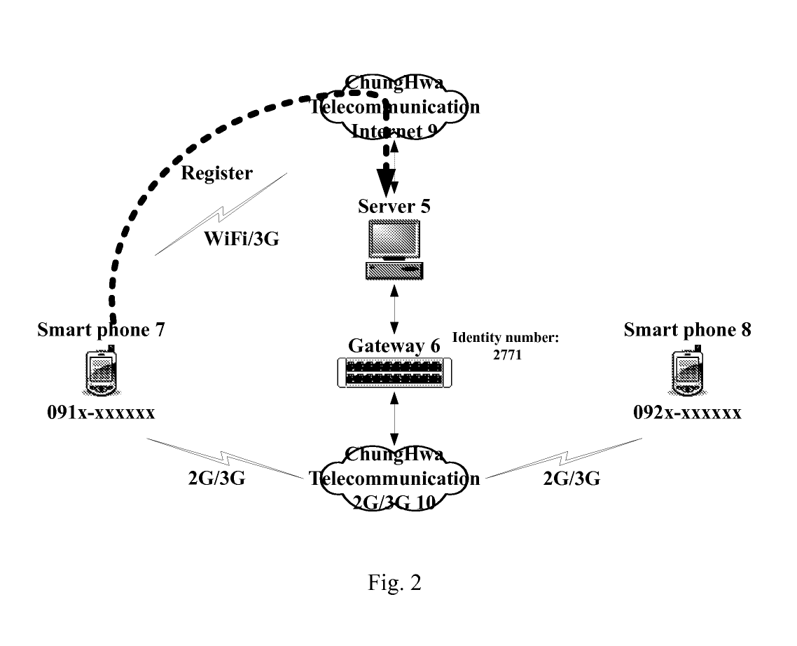

Referring to FIG. 2, an embodiment of a smart phone 7 to call a smart phone 8 by VoIP is shown, in which a server 5 uses ChungHwa Telecommunication 2G/3G 10 through a gateway 6 to inform the smart phone 8 for Internet connection.

The gateway 6 is set between the server 5 and ChungHwa Telecommunication 2G/3G 10. The gateway 6 has an identity number of 2771 and is responsible for transmitting messages between a PSTN (Public Switched Telephone Network) and an Internet. Both the smart phone 7 and the smart phone 8 are not connected with ChungHwa Telecommunication Internet 9.

As shown in FIG. 2, when the smart phone 7 calls the smart phone 8 through VoIP, the smart phone 7 has to perform a connection through WiFi/3G network. After the connection is succeeded, a “register” message is sent to the server 5 for verificating the user's information of the smart phone 7 (such as the number of the smart phone, account number, password, . . . etc.).

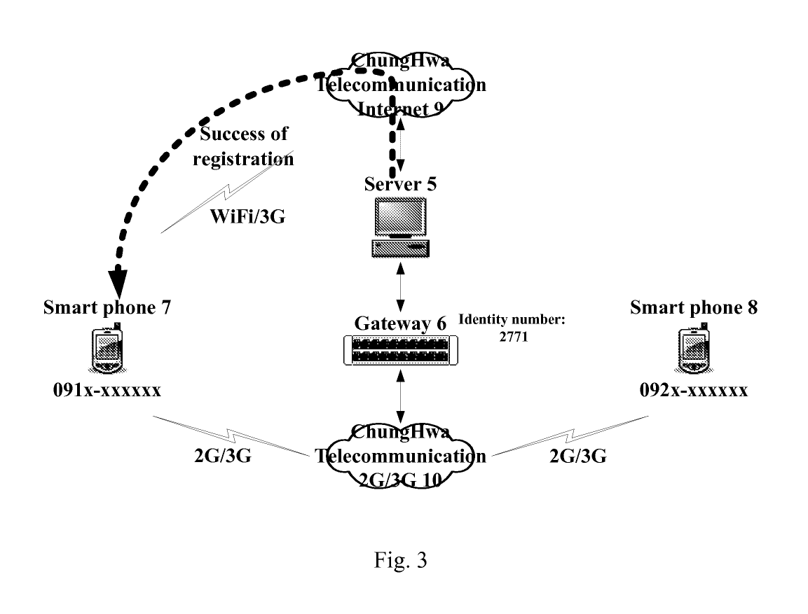

As shown in FIG. 3, after the verification by the server 5 is succeeded, a “success of registration” is sent to the smart phone 7 to let the smart phone 7 make a call by VoIP.

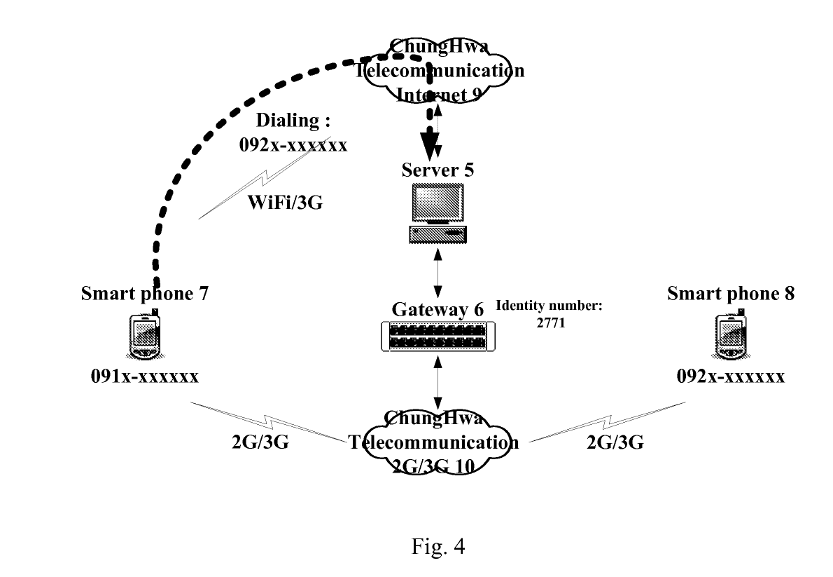

As shown in FIG. 4, the smart phone 7 sends out “dialing 092x -xxxxxx” message packet through WiFi/3G network to the server 5.

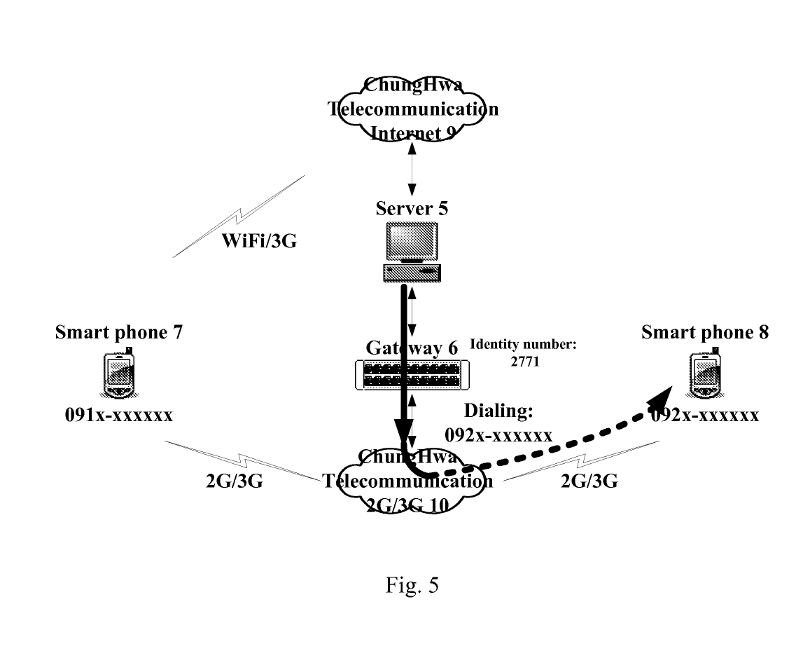

As shown in FIG. 5, after the server 5 receives the packet, the packet is analyzed to take out the telephone number “092x-xxxxxx”, and then pass through the gateway 6 to use ChungHwa Telecommunication 2G/3G 10 for dialing the smart phone 8, just like a local call to dial a mobile phone.

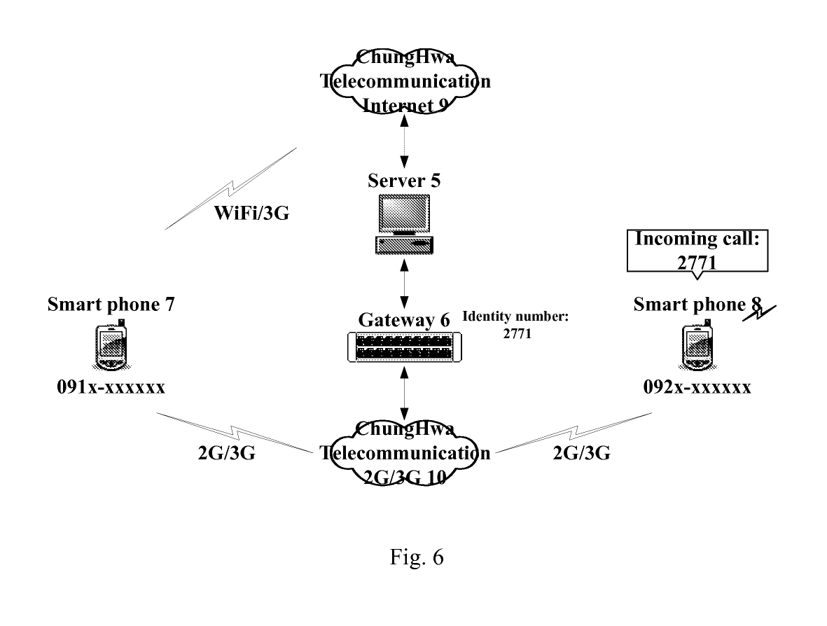

As shown in FIG. 6, after the dialing is succeeded, the smart phone 8 will ring, and the phone number of the incoming call is the number 2771 of the gateway 6.

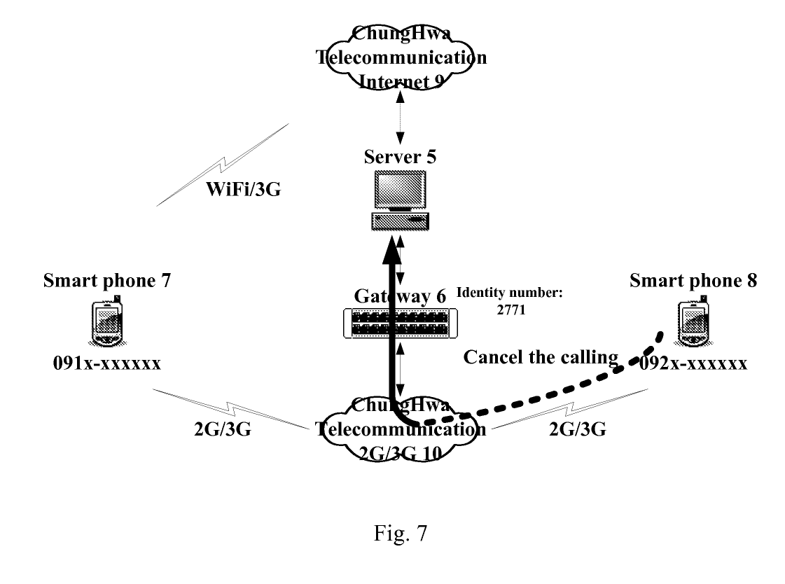

As shown in FIG. 7, when the smart phone 8 receives the number 2771 of the gateway 6, the smart phones 8 knows that someone is using VoIP for calling, so the smart phone 8 cancels the calling through ChungHwa Telecommunication 2G/3G 10.

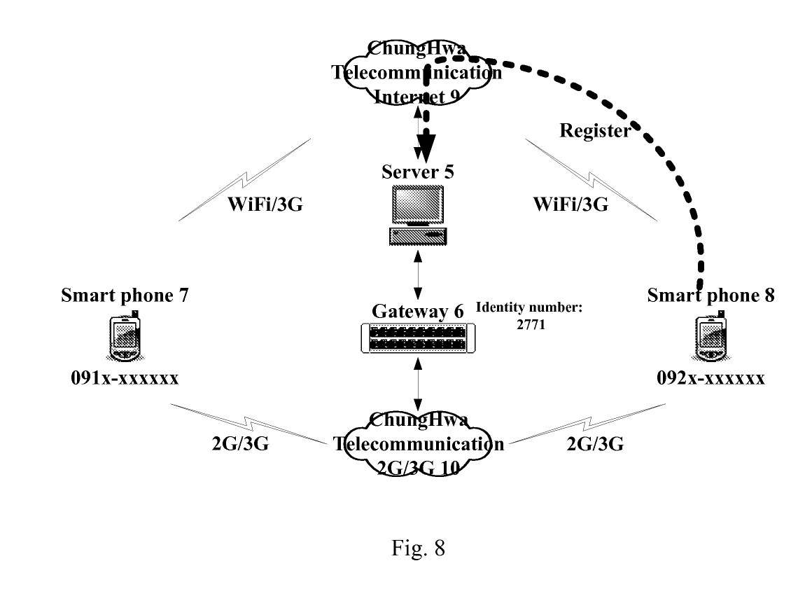

As shown in FIG. 8, after canceling the call, the smart phone 8 connects with the ChungHwa Telecommunication Internet 9 through WiFi/3G immediately. After the connection is succeeded, the smart phone 8 sends “register” message to the server 5 for verificating the user's information of the smart phone 8 (such as the number of the smart phone, account number, password, . . . etc.).

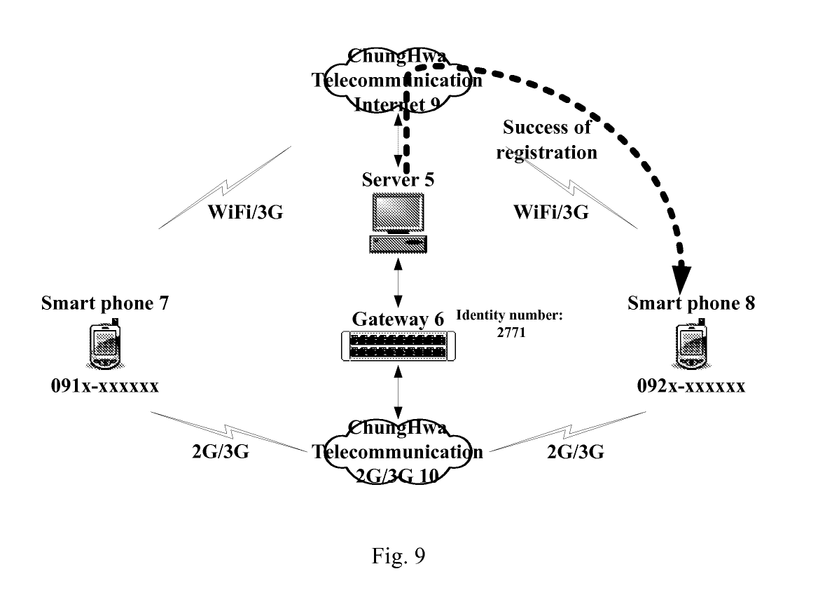

As shown in FIG. 9, after the verification by the server 5 is succeeded, a “success of registration” is sent to the smart phone 8.

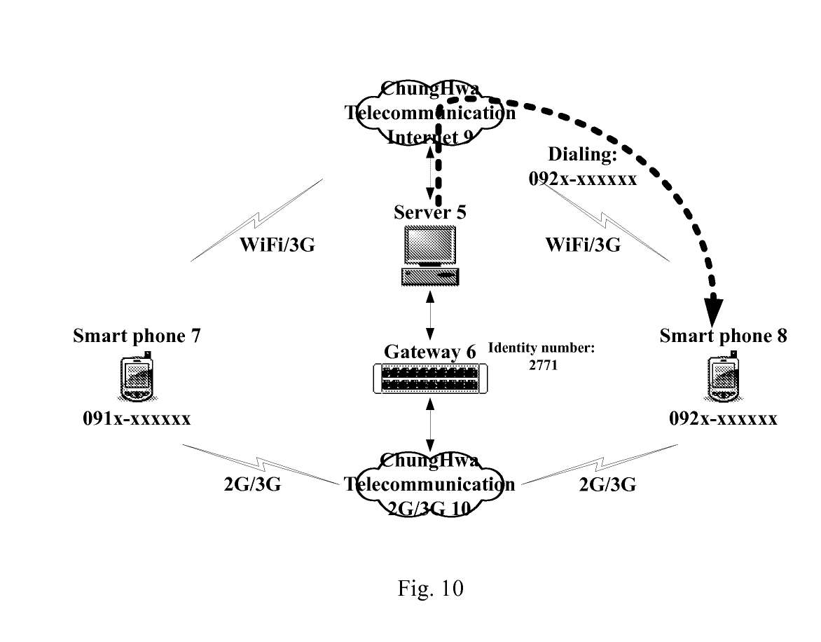

As shown in FIG. 10, the server 5 sends out “dialing 092x-xxxxxx” message packet to the smart phone 8.

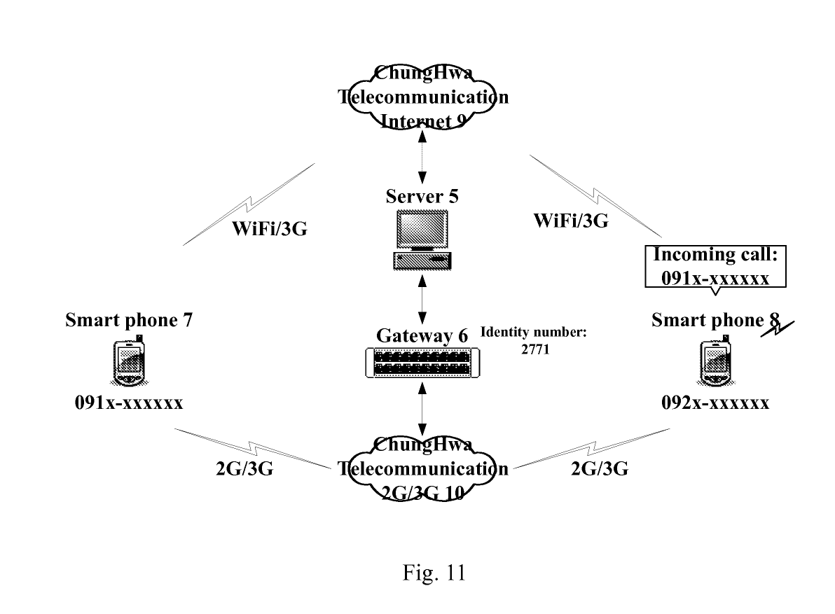

As shown in FIG. 11, after the dialing is succeeded, the smart phone 8 begins ringing, and the phone number of the incoming call is the phone number 091x-xxxxxx of the smart phone 7.

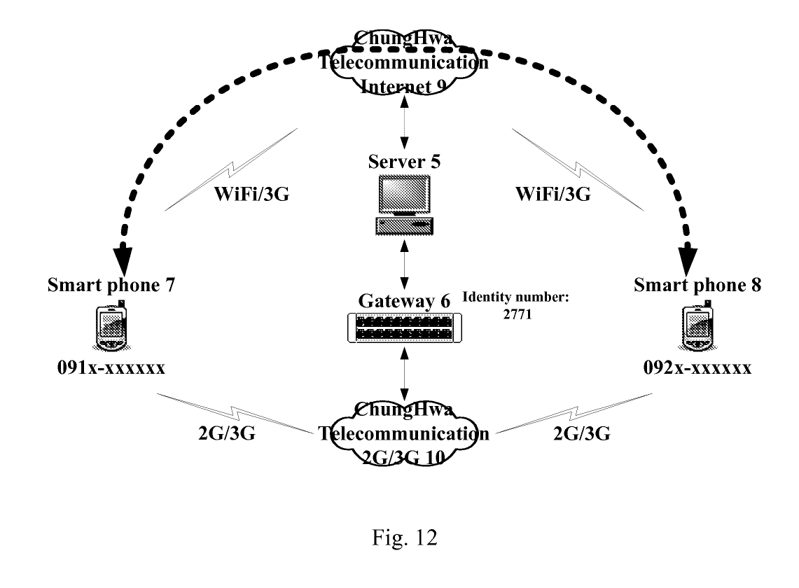

As shown in FIG. 12, after the smart phone 8 picks up the call, and finishes all procedures of the VoIP communication protocol, both sides begin communication through the ChungHwa Telecommunication Internet 9.

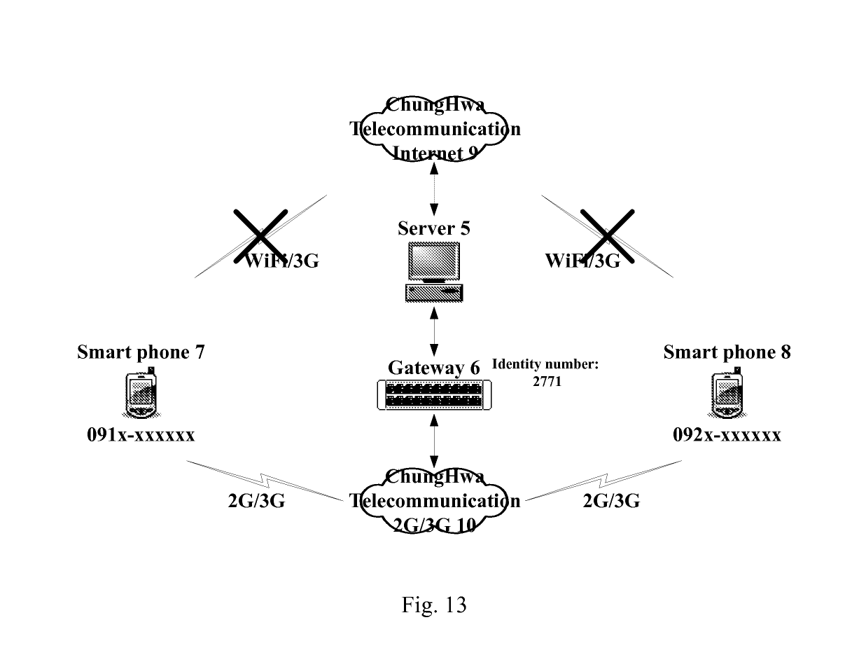

As shown in FIG. 13, after both sides stop communication, the smart phone 7 and the smart phone 8 cut off the WiFi/3G Internet connections automatically.

If one of the smart phone 7 and the smart phone 8 is going to make a VoIP call to the other side, just repeat the procedures shown in FIG. 2-13.

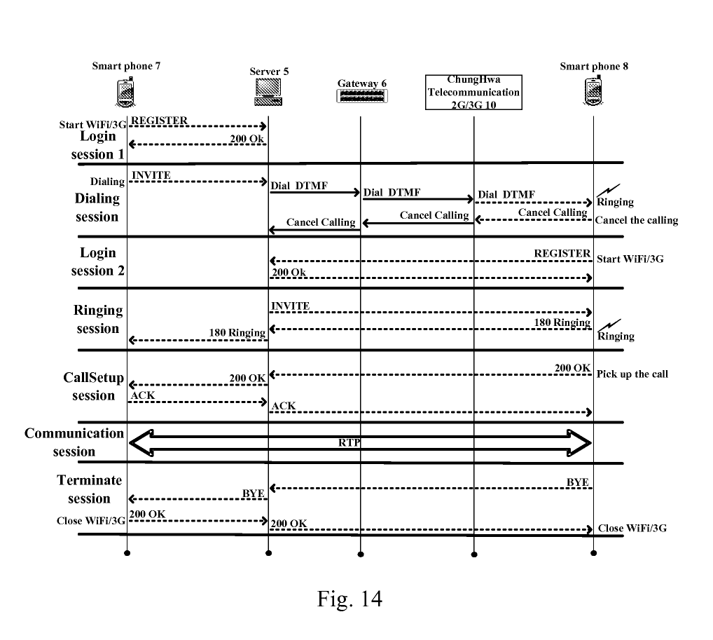

The software method of the present invention is described in the procedures shown in FIG. 14. Firstly suppose that both sides are going to use VoIP communication, the smart phone 7 and the smart phone 8 are not connected to ChungHwa Telecommunication Internet 9.

As shown in FIG. 14, the smart phone 7, the smart phone 8 and the server 5 communicate through SIP (Session Initial Protocol) in VoIP. The SIP has Login session 1, Dialing session, Login session 2, Ringing session, CallSetup session, Communication session and Terminate session.

Before the smart phone 7 dials VoIP to the smart phone 8, the smart phone 7 has to connect with a WiFi/3G Internet, and register to the server 5. After the registration is succeeded, the server 5 will respond with a 200 OK message. This is the Login session 1.

Then the smart phone 7 dials the phone number, sends INVITE message to the server 5. The server 5 then passes through the gateway 6 to use ChungHwa Telecommunication 2G/3G 10 for issuing Dial DTMF to the smart phone 8. After the dialing is succeeded, the smart phone 8 begins ringing, then cuts off the connection, and passes the gateway 6 through ChungHwa Telecommunication 2G/3G 10 to send Cancel Calling message to the server 5. This is the Dialing session.

The smart phone 8 starts WiFi/3 G Internet connection, and sends REGISTER message to the server 5. After the registration is succeeded, a 200 OK message will be obtained from the server 5. This is the Login session 2.

The server 5 transmits the INVITE message from the smart phone 7 to the smart phone 8, then the smart phone 8 begins ringing and returns a 180 Ringing message to the server 5, the server 5 will then transmit the 180 Ringing message to the smart phone 7. This is the Ringing session.

After the smart phone 8 picks up the call, a 200 OK message will be sent to the smart phone 7 through the server 5. The smart phone 7 returns an ACK message to the smart phone 8 through the server 5. This is the CallSetup session.

Thereafter, both sides enter the Communication session, the VoIP of both sides communicate with each other by RTP (Real Time Transport Protocol). This is the Communication session.

After the smart phone 8 finishes the communication, a BYE message is sent to the smart phone 7 through the server 5, and a 200 OK message is returned by the smart phone 7 to the smart phone 8 through the server 5, both the smart phone 7 and the smart phone 8 cut off the WiFi/3G Internet connection. This is the Terminate session.

The advantages of the present invention are:

1. Since the smart phone 7 and the smart phone 8 are usually not connected with ChungHwa Telecommunication Internet 9, the harm of electromagnetic wave is avoided.

2. The power consumption of the smart phone is reduced, since the smart phone is usually not connected with ChungHwa Telecommunication Internet 9, only when there is a call from the mobile communication network, then the smart phone will begin Internet connection.

3. The present invention is not limited to VoIP, other systems such as Skype, MSN, Yahoo! messenger . . . etc. also can be used in the present invention.

4. The present invention is not limited to SIP, other protocols such as Skype, H.323, MGCP . . . etc. also can be used in the present invention.

5. Any smart mobile communication device with the mechanism of Internet connection such as Tablet PC, PDA can be applied to the present invention.

6. Any wireless communication system such as WiFi, 3G that can make the smart mobile communication device connect with the Internet is suitable to the present invention.

7. The present invention is not limited by the mobile communication network 4 in the aforementioned embodiment, other method such as short message for informing is also suitable to the present invention.

8. The present invention is not limited by the gateway 6 in the aforementioned embodiment, other device that can connect between two different networks and can handle the transformation of communication protocols is also suitable to the present invention.

The scope of the present invention depends upon the following claims, and is not limited by the above embodiments.

What is claimed is:

1. A power saving system for a smart mobile communication device in Internet communication, comprising:
a first smart mobile communication device having Internet connection capability;
a second smart mobile communication device having Internet connection capability;
an Internet;
a mobile communication network;
a server;
a gateway;
the first and the second smart mobile communication device usually cut off the Internet connection;
when the first smart mobile communication device calls the second smart mobile communication device through the Internet, the server will judge if the second smart mobile communication device is on-line, if yes, then do some verifications, exchange communication messages for both sides; if no, then the server will use the mobile communication network through the gateway to inform the second smart mobile communication device for Internet connection; after the second smart mobile communication device receives the informing, the second smart mobile communication device begins Internet connection, and registers to the server; then the server knows an Internet address of the second smart mobile communication device, so as to exchange communication messages for both sides; after both sides stop the Internet communication, the first and the second smart mobile communication device cut off the Internet connection.

2. The power saving system for a smart mobile communication device in Internet communication according to claim 1, wherein the Internet can be replaced by IP Phone, Skype, MSN or Yahoo! messenger.

3. The power saving system for a smart mobile communication device in Internet communication according to claim 1, wherein the smart mobile communication device can be a smart phone, a tablet PC or a PDA having smart communication capability.

4. The power saving system for a smart mobile communication device in Internet communication according to claim 1, wherein the Internet is a WiFi/3G system, but other network system that can provide wireless connection between the first and the second smart mobile communication devices can also be used.

5. The power saving system for a smart mobile communication device in Internet communication according to claim 1, wherein the mobile communication network can use a short message to inform the second smart mobile communication device for Internet connection.

6. The power saving system for a smart mobile communication device in Internet communication according to claim 1, wherein the gateway can be replaced by other device that can connect between two different networks and can handle the transformation of communication protocols.
